(19) United States
(12) Patent Application Publication
(10) Pub. No.: US 2003/0217437 A1
(43) Pub. Date: Nov. 27, 2003

(54) Handle for tool bits

(76) Inventor: Martin Chen, Chang Hua City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/155,347

(22) Filed: May 23, 2002

(51) Int. Cl. E05B 1/00

(52) U.S. Cl. 16/422

(57) ABSTRACT

A handle includes a grip and a connector in connection with the grip for removable connection with a shank of a tool bit. The grip includes an extension. The connector includes a first section for connection with the extension of the grip and a second section for connection with the shank of the tool bit. The second section of the connector defines a space for receiving the shank of the tool bit. A stabilizer includes an insert for insertion in the space defined in the second section of the connector and a flange projecting from the insert for avoiding the insert of the stabilizer getting too deep to be pulled out. The second section of the connector defines an aperture in communication with the space. A bolt is driven through the aperture into the space so as to abut the insert of the stabilizer. The first section of the connector defines a space for receiving the extension of the grip. The extension of the grip defines a space for receiving the shank of the tool bit. The extension of the grip defines a first space and a second space. One of the first and second spaces defined in the extension of the grip can be selected to receive the shank of the tool bit. The first and second spaces defined in the extension of the grip are in communication with each other. The first section of the connector defines four apertures. Two bolts are driven through two of the apertures defined in the first section of the connector into contact with the extension of the grip. The extension of the grip defines two recesses for receiving the bolts.

### BACKGROUND OF INVENTION

1. Field of Invention

The present invention relates to a handle for tool bits.

2. Related Prior Art

Taiwanese Patent Publication No. 371191 discloses a new design of a handle for knifes. The handle is made hollow in order to receive a shank of a knife. The connection of the handle with the knife Proper can be secured by any appropriate means. Once the connection is secured, the handle and the knife cannot be disengaged from each other. Therefore, a handle can be connected with only one knife. If more than one knife or tool is needed, a same amount of handles are needed. This causes unnecessary burden for users. Furthermore, when more than one knife or tool is stored in a box, the blade of a knife or the tool bit of a tool may damage the handles of other knifes or tools.

The present invention is therefore intended to obviate or at least alleviate the problems encountered in prior art.

### SUMMARY OF INVENTION

It is an objective of the present invention to provide a handle for tool bits.

It is another objective of the present invention to provide a handle for holding various tool bits in a removable manner.

According to the present invention, a handle includes a grip and a connector in connection with the grip for removable connection with a shank of a tool bit.

The grip includes an extension. The connector includes a first section for connection with the extension of the grip and a second section for connection with the shank of the tool bit.

The second section of the connector defines a space for receiving the shank of the tool bit.

A stabilizer includes an insert for insertion in the space defined in the second section of the connector and a flange projecting from the insert for avoiding the insert of the stabilizer getting too deep to be pulled out.

The second section of the connector defines an aperture in communication with the space. A bolt is driven through the aperture into the space so as to abut the insert of the stabilizer.

The first section of the connector defines a space for receiving the extension of the grip.

The extension of the grip defines a space for receiving the shank of the tool bit.

The extension of the grip defines a first space and a second space. One of the first and second spaces defined in the extension of the grip can be selected to receive the shank of the tool bit. The first and second spaces defined in the extension of the grip are in communication with each other.

The first section of the connector defines four apertures. Two bolts are driven through two of the apertures defined in the first section of the connector into contact with the extension of the grip.

The apertures are evenly located around the first section of the connector. The bolts are driven through two opposite ones of the apertures.

The extension of the grip defines two recesses for receiving the bolts. The recesses defined in the extension of the grip are opposite to each other.

The first space defined in the protrusion of the grip may extend into the grip in order to receive a long shank.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of a knife connected with a handle in a first position according to the present invention;

FIG. 2 is an exploded view of the knife and the handle shown in FIG. 1;

FIG. 3 is similar to FIG. 1 except that the handle is broken in order to show details about connection of the knife with the handle;

FIG. 4 is a cross-sectional view of the knife and the handle shown in FIG. 1;

FIG. 5 is a perspective view of a saw of a first type connected with the handle according to the present invention;

FIG. 6 is a perspective view of a saw of a second type connected with the handle according to the present invention;

FIG. 7 is an exploded view of a scraper and the handle in a second position according to the present invention; and

FIG. 8 is a perspective view of the scraper and the handle shown in FIG. 7; the handle is broken so as to show details about connection of the scraper with the handle.

### DETAILED DESCRIPTION OF PREFERRED EMBODIMENT

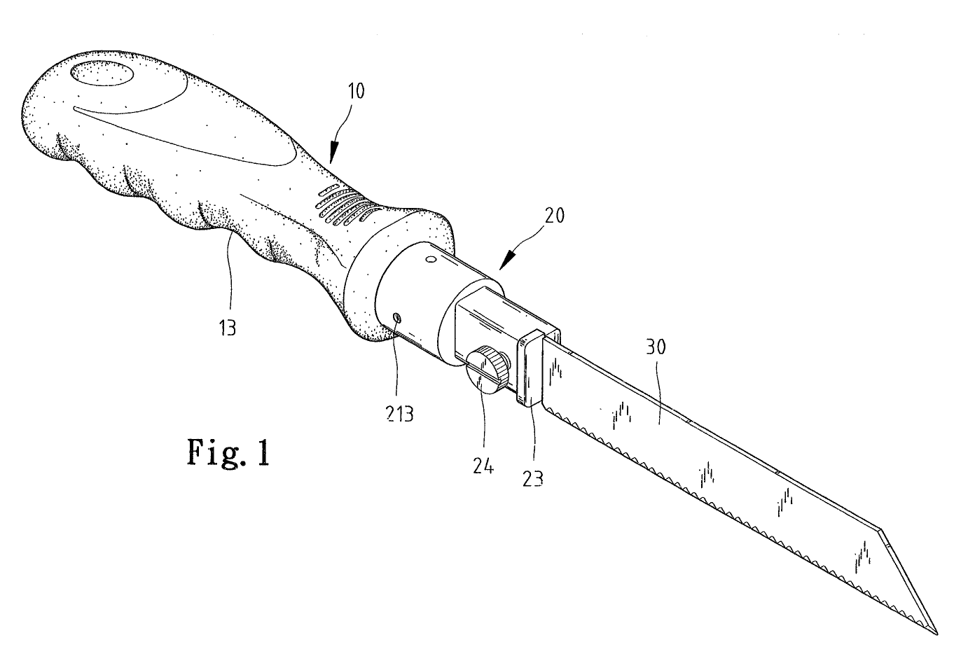

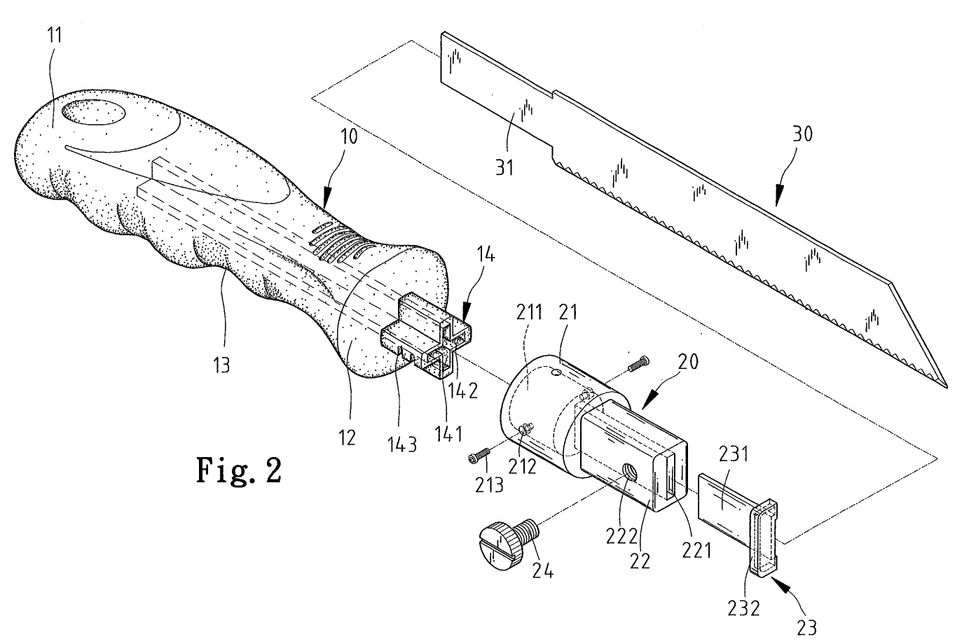

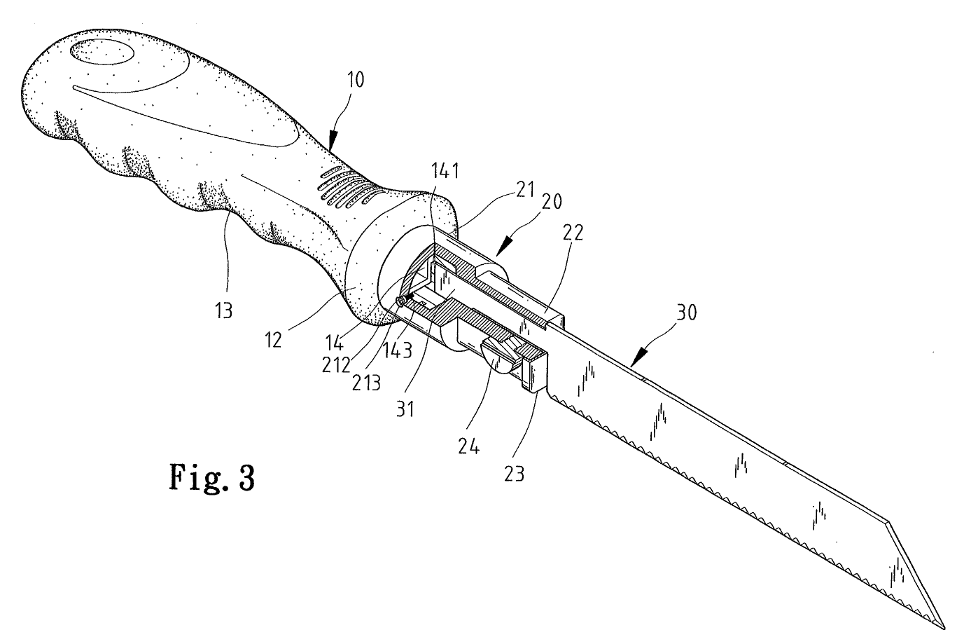

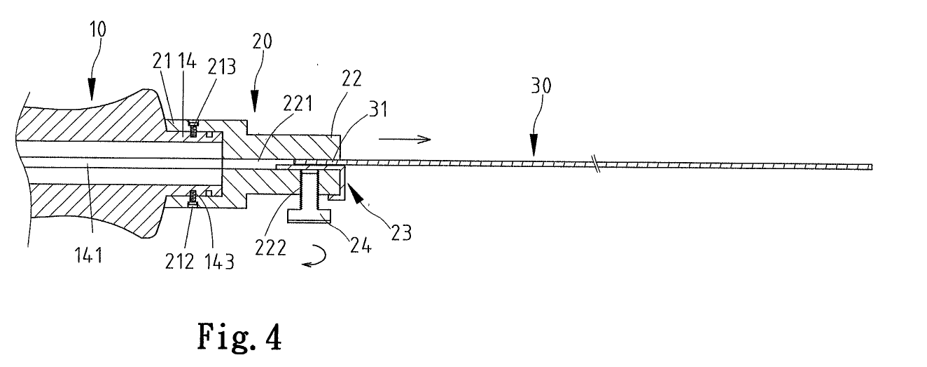

Referring to FIGS. 1-4, a handle according to the preferred embodiment of the present invention includes a grip 10 and a connector 20. The handle is in a first position for connection with a knife 30.

The grip 10 includes a first end 11, a second end 12 and a curved surface 13 formed thereon between the ends 11 and 12 in order to receive fingers of a user. The grip 10 includes an extension 14 extending from the second end 12. Two flat spaces 141 and 142 are defined in the grip 10 and through the extension 14 of the grip 10. The spaces 141 and 142 are in communication with each other so that they become a space that is like a cross when viewed in an axial direction. Two recesses 143 are defined in opposite sides of the extension 14 of the grip 10.

The connector 20 includes a first section 21 for connection with the extension 14 of the grip 10 and a second section 22 for connection with a shank 31 of the knife 30. The first section 21 of the connector 20 defines a space 211 in which the extension 14 of the grip 10 is inserted. Four apertures 212 extend through the first section 21 of the connector 20. The apertures 212 are evenly located around the first section 21 of the connector 20. Two bolts 213 can be driven through two opposite ones of the apertures 212 into the recesses 143, thus securing connection of the first section 21 of the connector 20 with the extension 14 of the grip 10. The second section 22 of the connector 20 defines a space 221 in which the shank 31 of the knife 30 is inserted. The second section 22 of the connector 20 defines an aperture 222 in communication with the space 221. A stabilizer 23 includes an insert 231 and a flange 232 projecting from the insert 231. The insert 231 of the stabilizer 23 can be inserted in the space 221 so that it is located against the shank 31 of the knife 30. The flange 232 of the stabilizer 23 avoids the insert 231 of the stabilizer 23 getting too deep to be pulled out. A bolt 24 is driven through the aperture 222 into the space 221 so as to press the insert 231 of the stabilizer 23, thus firmly holding the shank 31 of the knife 30.

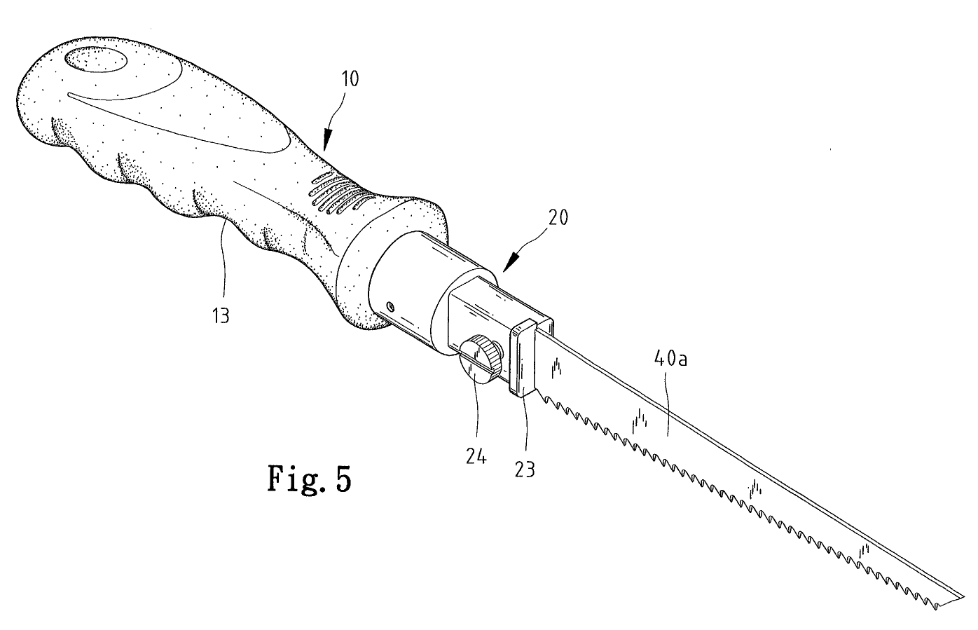

FIG. 5 shows a saw 40a connected with the handle according to the preferred embodiment of the present invention.

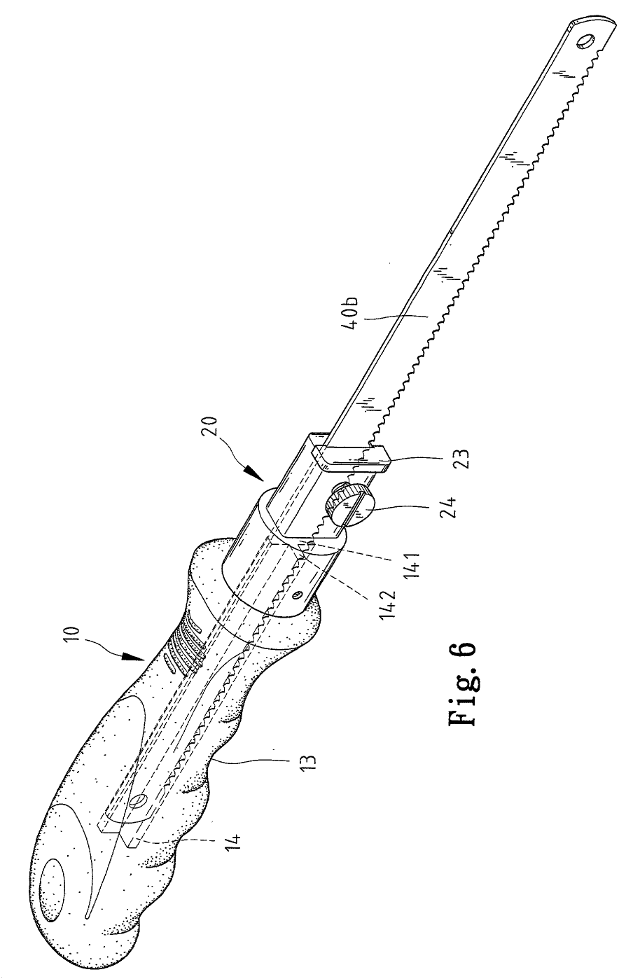

FIG. 6 shows a saw 40b connected with the handle according to the preferred embodiment of the present invention. The saw 40b is long. To avoid buckling of the saw 40b in use, a substantial portion of the saw 40b is inserted in the space 141.

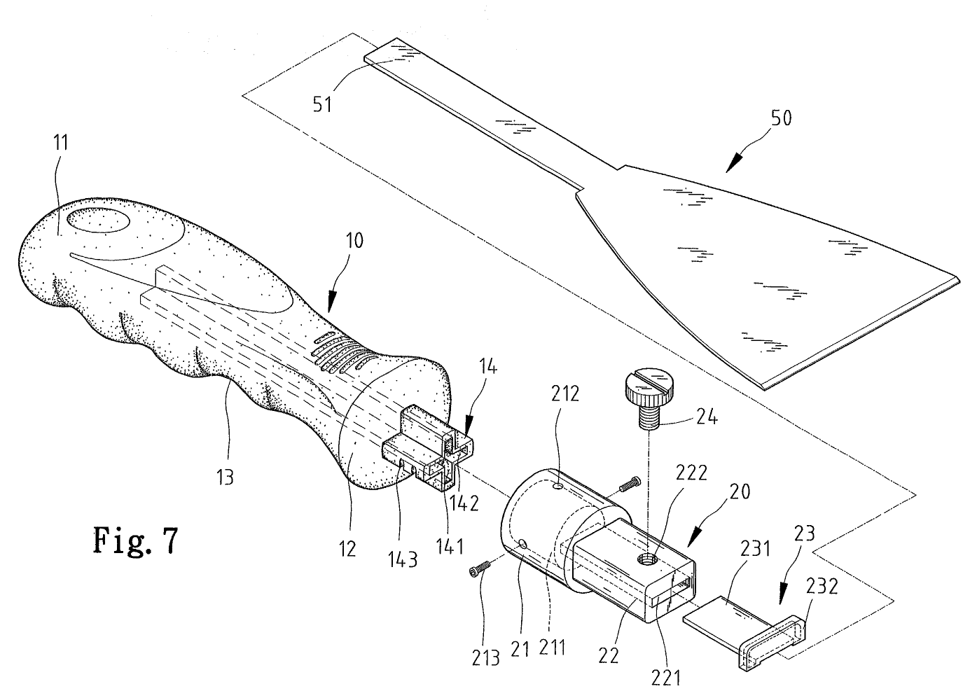

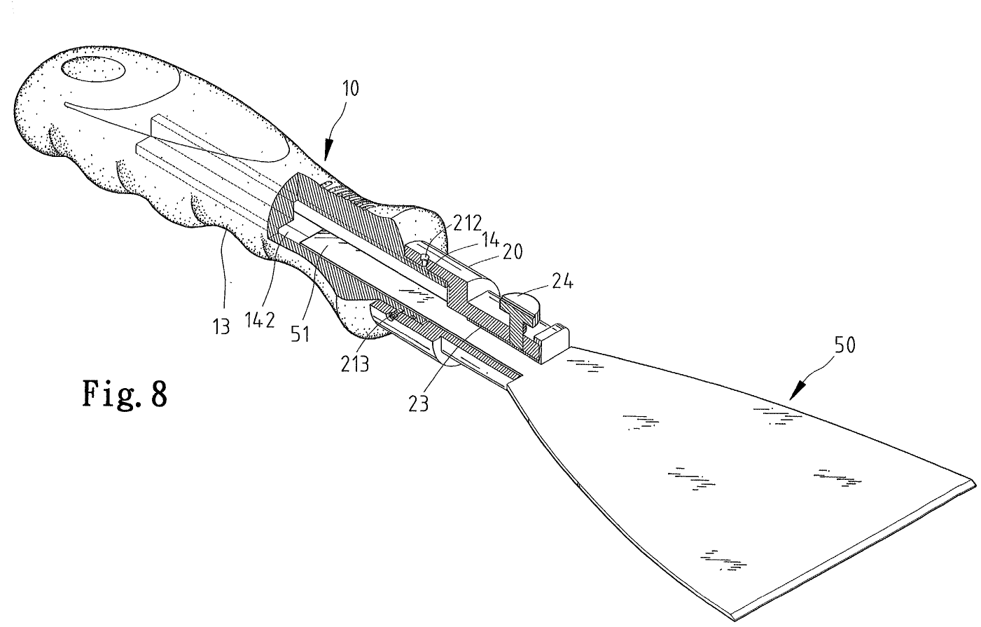

FIGS. 7 and 8 show a scraper 50 connected with the handle according to the preferred embodiment of the present invention. The connector 20 is rotated from the position shown in FIGS. 1˜6 by an angle of 90 degrees so as to receive a shank 51 of the scraper 50. The shank 51 of the scraper 50 is inserted through the space 221 into the space 142.

The present invention has been described via detailed illustration of the preferred embodiment. Those skilled in the art can derive many variations from the preferred embodiment without departing from the scope of the present invention. Therefore, the preferred embodiment shall not limit the scope of the present invention. The scope of the present invention is defined in the attached claims.

1. A handle including a grip (10) and a connector (20) in connection with the grip (10) for removable connection with a shank of a tool bit.

2. The handle according to claim 1 wherein the grip (10) includes an extension (14) and the connector (20) includes a first section (21) for connection with the extension (14) of the grip (10) and a second section (22) for connection with the shank of the tool bit.

3. The handle according to claim 2 wherein the second section (22) of the connector (20) defines a space (221) for receiving the shank of the tool bit.

4. The handle according to claim 3 including a bolt (24) wherein the second section (22) of the connector 20 defines an aperture (222) in communication with the space (221) and the bolt (24) is driven through the aperture (222) into the space (221) so as to abut the shank of the tool bit.

5. The handle according to claim 3 including a stabilizer (23) inserted in the space (221) defined in the second section (22) of the connector (20) against the shank of the tool bit.

6. The handle according to claim 5 including a bolt (24) wherein the second section (22) of the connector (20) defines an aperture (222) in communication with the space (221) and the bolt (24) is driven through the aperture (222) into the space (221) so as to abut the stabilizer (23).

7. The handle according to claim 5 wherein the stabilizer (23) includes an insert (231) for insertion in the space (221) defined in the second section (22) of the connector (20) and a flange (232) projecting from the insert (231) for avoiding the insert (231) of the stabilizer (23) getting too deep to be pulled out.

8. The handle according to claim 7 including a bolt (24) wherein the second section (22) of the connector (20) defines an aperture (222) in communication with the space (221) and the bolt (24) is driven through the aperture (222) into the space (221) so as to abut the insert (231) of the stabilizer (23).

9. The handle according to claim 2 wherein the first section (21) of the connector (20) defines a space (211) for receiving the extension (14) of the grip (10).

10. The handle according to claim 9 wherein the extension (14) of the grip (10) defines a space (141; 142) for receiving the shank of the tool bit.

11. The handle according to claim 10 wherein the extension (14) of the grip (10) defines a first space (141) and a second space (142) and one of the first and second spaces can be selected to receive the shank of the tool bit.

12. The handle according to claim 11 wherein the first and second spaces (141, 142) are in communication with each other.

13. The handle according to claim 12 wherein the first section (21) of the connector (20) defines four apertures (212) through two of which two bolts (213) are driven into contact with the extension (14) of the grip (10).

14. The handle according to claim 13 wherein the extension (14) of the grip (10) defines two recesses (143) for receiving the bolts (213).

15. The handle according to claim 11 wherein the first space (141) extends into the grip (10) in order to receive a long shank.
